(19) United States
(12) Patent Application Publication
(10) Pub. No.: US 2004/0082421 A1
(43) Pub. Date: Apr. 29, 2004

(54) Split performance power train

(76) Inventor: Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/679,552

(22) Filed: Oct. 6, 2003

(30) Foreign Application Priority Data
Oct. 24, 2002 (DE) 102 49 485.1

(51) Int. Cl. F16H 37/02

(52) U.S. Cl. 475/207

(57) ABSTRACT

A split performance power train is proposed, comprising a friction wheel variable speed transmission and a planetary gear set laid out as an accumulated set of gears. A first planetary gear set (2) and a third planetary gear set (4) are envisioned and the friction wheel variable speed transmission (1), the first planetary gear set (2) and the second planetary gear set (3) are laid out as an accumulated set of gears and the third planetary gear set (4) is coaxial and arranged consecutively in the direction of the flow of the power.

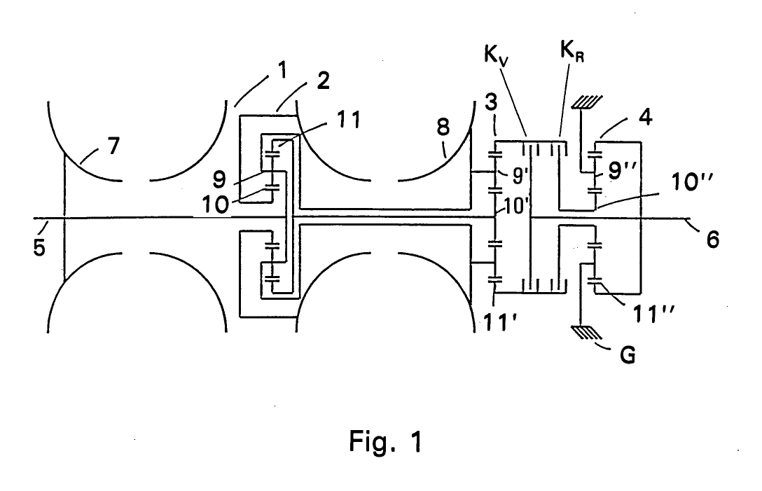

The present invention refers to a split performance power train, according to the preamble of patent Claim 1, which comprises a friction wheel variable speed gear.

Continuously adjustable friction wheel variable speed gears, which have at a minimum two toroidal disks with toroid form bearing surfaces between which the rolling elements unwind are well known from the state-of-the-art technology. Next to the continuous gearing change, such friction wheel variable speed gears also have a high torque capacity.

A power train that can operate at two ranges of capacity is known from DE 196 29 213. The essential components of this known friction wheel transmission are a continuously adjustable friction wheel variable speed gear with two paired combined effect toroidal form bearing surfaces, a countershaft, as well as a summation set of gears. A split performance is hereby planned in the lower domain (LOW). The driving power is transmitted from the primary shaft over a stepped gear, then to the countershaft and subsequently to continuously adjusted transmission (friction wheel variable speed gear) that is linked by the power take off side with the summation set of gears. Over a second performance split, the driving power is transmitted over the countershaft and a gearing step directly to the summation drive where the power of both split powers is added up and transmitted on to the drive shaft.

In the second performance region (HIGH) of this known transmission, the driving power is passed over a transmission gear to the countershaft and subsequently to the continuously adjustable mechanism. Further power sharing is not foreseen in this case.

Another transmission is known to the applicant from DE 197 03 544 A1 in which a power split is foreseen and a continuously adjustable transmission is used, especially gears with a paired combined effect, toroid form bearing surfaces (friction wheel drive). This known transmission also points to an intermediate shaft or a countershaft, as the case may be, in order to achieve the desired power split. According to DE 197 03 544 A1, in the first power area of the transmission, the power is transmitted from the drive shaft over friction wheel variable speed gears to the drive shaft, wherein the planetary gears run as one unit; in the second power area, the power is transmitted over friction wheel variable speed gears to the planetary gears and, second, directly to the planetary gears, whereby the performance of the planetary gears is summated and transmitted to the drive shaft.

Envisioned through the state-of-the-art technology, a side shaft for a power split will require substantial amount of building space that is currently required for other drive train components. In addition, such concepts are only conditionally suitable for front-lengthwise mounting.

The invention mentioned above is founded on the task of going from the given state-of the-art technology to claim a transmission that has the convenient advantages of a continuously variable transmission with a combination of small space requirement and low production and maintenance costs.

This goal has been achieved by the characteristics of patent Claim 1. Further designs and advantages become apparent in the sub-claims.

Accordingly, a split performance powertrain is proposed that encompasses a friction wheel variable speed transmission, a first planetary gear set, a second planetary gear set, and a third planetary gear set, wherein the friction variable speed transmission and the planetary gear sets are arranged coaxially.

According to this invention, the power is transmitted coaxially by friction wheel variable speed transmission over the first planetary gear set through the friction wheel variable speed transmission to the second one, as a summation set of gears functioning as a planetary gear set. Finally, the power is transmitted to the third planetary gear set linked to the drive shaft.

This design will not require a side shaft, which will result in a very compact construction style.

The invention will be further clarified in the following discussion based on a figure of a model that represents the preferred structural form of a transmission according to this invention.

According to the Figure, the transmission made according to this invention encompasses a friction wheel variable speed transmission 1, three planetary gear sets 2, 3, and 4, a motor shaft 5, a drive shaft 6, and two clutches Kv and Kr.

The external toroid disks 7, 8 of the friction wheel variable speed transmission 1 will act upon the speed of the engine; which occurs at the toroid disk 7 directly and at the second toroid disk 8 across the fixed link 9 of the first planetary gear set 2, which is coaxially arranged for that purpose between the paired disks and the friction wheel variable speed transmission. Additionally, the motor shaft is linked over the fixed link 9 of the first planetary gear set 2 with the fixed link 9′ of the second planetary gear set.

The drive shaft power of the variable speed gear 1 is transmitted to the sun wheel 10 of the first planetary gear set 2; subsequently, this motor shaft performance, provided with the transmission of the first planetary gear set 2 over the ring gear 11 of the first planetary gear set 2, is transmitted through the second paired disks of the variable speed gear (seen in the power flow direction) to the sun wheel 10′ of the second planetary gear set 3. In the second planetary gear set 3, the part of the variable speed gear 1 and a direct part of the engine speed accumulate, and, by activation of one of the two clutches Kv and Kr, are transmitted over their ring gear 11′ to the drive shaft 6.

The activation of the Kv clutch affects a linkage of the drive shaft 6 with the ring gear 11′ of the second planetary gear set 3, whereby the drive shaft 6 turns in the same direction as the motor shaft (moving forward). For a reverse drive, the Kr clutch is locked, which affects a linkage of the ring gear 11′ of the second planetary gear set 3 with the sun wheel 10″ of the third planetary gear set. Thus the power across the ring gear 11″ of the third planetary gear set 4 is transmitted to the drive shaft 6. The fixed link 9″ of the third planetary gear set 4 is linked with the housing G.

A typical value for the inclination of the friction wheel variable speed transmission is 5, whereby an advantageous value for the standing gearing of the first planetary gear set 2 is approx. −2.0, approx. −1.72 for the second planetary gear set 3, and approx. −1.70 for the standing gearing of the power take off side arranged third planetary gear set 4. The transmission according to this invention represents a very high transmission inclination with the upper standing transmission gearing of 10.0. Depending on the design of the transmission, however, other values are also possible.

Through the concept according to the invention, very high starting gear ratio can be realized so that no starting gear is necessary. Within the scope of an additional design form, a single friction wheel variable speed transmission can be used in order to achieve an even more compact mechanism.

Reference numbers

| | |
|---|---|
| 1 | Friction wheel variable speed transmission |
| 2 | First planetary gear set |
| 3 | Second planetary gear set |
| 4 | Third planetary gear set |
| 5 | Motor shaft |
| 6 | Drive shaft |
| 7 | External toroid plate |
| 8 | External toroid plate |
| 9 | Fixed link |
| 9′ | Fixed link |
| 9″ | Fixed link |
| 10 | Sun wheel |
| 10′ | Sun wheel |
| 10″ | Sun wheel |
| 11 | Ring gear |
| 11′ | Ring wheel |
| 11″ | Ring wheel |
| Kv | Clutch |
| Kr | Clutch |
| G | Housing |

1. The split performance power train, comprising a friction wheel variable speed transmission and a planetary gear set designed as a summation set of gears, is characterized in that a first planetary gear set (2) and a third planetary gear set (4) are planned, whereby the friction wheel variable speed transmission (1), the first planetary gear set (2), the second planetary gear set (3) and the third planetary gear set (4) are coaxial and arranged consecutively in the direction of the power flow.

2. The split performance power train, according to claim 1, is characterized in that the transmitted power in the friction wheel variable speed transmission (1) over the first planetary gear set (2) is transmitted coaxially through the friction wheel variable speed (1) to the second planetary gear set (3).

3. The split performance power train, according to claim 1 or 2 is characterized in that the third planetary gear set (4) is arranged at the side of the output.

4. Split performance power train, according to one of the preceding claims, is characterized in that the first planetary gear set (2) is arranged between the paired disks of the friction wheel variable speed transmission (1).

5. Split performance power train according to one of the preceding claims is characterized in that it has two clutches (Kv and Kr), whereby the (Kv) clutch forms a detachable link in the motor shaft (6) with the ring gear (11′) of the second planetary gear set (3) and the (Kr) clutch forms a detachable link with the ring gear (11′) of the second planetary gear set (3) with the sun wheel (10″) of the third planetary gear set.

6. The split performance power train, according to one of the preceding claims, is characterized in that the external toroid disks (7 and 8) of the friction wheel variable speed transmission (1) act upon the engine speed, whereby one of the external toroid disks (7) is linked directly and the second toroid disk (8) is linked across the fixed link (9) of the first planetary gear set (2) with the motor shaft (5) and whereby the motor shaft (5) is linked across the fixed link (9) of the first planetary gear set (2) with the fixed link (9′) of the second planetary gear set (3).

7. The split performance power train, according to one of the preceding claims, is characterized in that the required power of the friction wheel variable speed transmission (1) is conducted to the sun wheel (10) of the first planetary gear set (2) where it is transmitted across the ring gear (11) of the first planetary gear set (2) through a second paired disk set of the friction wheel variable speed transmission (1), viewed in the direction of the flow of power, to the sun wheel (10′) of the second planetary gear set (3) and that in the second planetary gear set, the share of the friction wheel variable speed transmission (1) and the direct share of the engine speed accumulates across its ring gear (11′) by the activation of one of the two clutches Kv and Kr on the motor shaft (6).
